(19) United States
(12) Patent Application Publication
(10) Pub. No.: US 2025/0375709 A1
(43) Pub. Date: Dec. 11, 2025

(54) CLOUD-BASED PLATFORM FOR REAL-WORLD EXPERIMENTATION DRIVEN GAME INCUBATION AT SCALE

(71) Applicant: Sony Interactive Entertainment Inc., Tokyo (JP)

(72) Inventor: Chen Yao, San Mateo, CA (US)

(21) Appl. No.: 18/738,991

(22) Filed: Jun. 10, 2024

(51) Int. Cl. A63F 13/60; A63F 13/77

(52) U.S. Cl. CPC A63F 13/60; A63F 13/77; A63F 2300/6009

(57) ABSTRACT

A cloud-based platform significantly lowers the barrier to creating and testing gaming concepts. On the platform, game developers can publish and test a full game, or just a self-contained mission or activity, to allow maximum agility to test and get quick market feedback on a granular discrete set of gaming concepts.

### FIELD

The present application relates generally to cloud-based platforms for real-world experimentation driven game incubation at scale.

### BACKGROUND

There is a significant challenge facing indie game developers who lack resources and support to create high-quality, console-ready games. These developers may have innovative ideas worth testing, but there is no systematic pathway or effective channel to help them prototype, incubate, test, and evolve their games. Many developers create simple mobile games as their first attempt, but this can be intense for small indie developers, and the process of launching full-fledged iOS/Android apps and going through the app store publishing process can be daunting. When some games become successful, it can be difficult to transition to console platforms, and by the time they do, platform owners may have to compete for partner preferences without any unique advantage.

### SUMMARY

Present principles, in recognizing the above technical challenges, provide a cloud-based platform that significantly lowers the barrier to creating and testing gaming concepts. On the platform, game developers can publish and test a full game, or just a self-contained mission or activity, to allow maximum agility to test and get quick market feedback on a granular discrete set of gaming concepts.

Accordingly, a method includes providing a cloud-based service executed by at least one network server. The service provisioning cloud resources includes storage, compute power, and auto-scaling of at least a first prototype computer game for execution on at least a first game play device. The method includes deploying, from the service, the first prototype computer game to the first game play device and receiving back game play data from the first game play device. The method includes providing analysis results of the first game play data to an independent (indie) developer of the first prototype computer game.

In some embodiments the method may include using the service to provide a game design studio to help modify the first prototype computer game, and/or to test the first prototype computer game, and/or to execute at least one machine learning (ML) model to automate creation of at least one asset for the first prototype computer game. For example, the asset can include an image of a background game object, or character dialog, or a game character.

In example implementations the method may include providing an app to the first game play device enabling the first game play device to access the first prototype computer game. The first game play device can include a game console, a PC, or a mobile communication device.

In examples, the method can includes allowing the indie developer of the first prototype computer game to specify the game play data to be collected from the first game play device. For example, the game play data can include one or more of player engagement times, level completion rates, player retention rate, game play session length, player progression speed.

In another aspect, a processor system is configured to receive communication from an independent (“indie”) developer of a first prototype computer game at at least one server over a wide area network. The processor system also is configured to, using the server, enable the indie developer to develop the first prototype computer game. Also, the processor system is configured to, using the server, provide the first protype computer game over the wide area network to at least a first game play device. Further, the processor system is configured to receive game play data at the server from the first game play device executing the first prototype computer game, and provide analysis of the game play data to the indie developer.

In another aspect, an apparatus includes at least one computer memory that is not a transitory signal and that in turn includes instructions executable by at least one processor system to establish on at least one network server a facility to allow game developers to develop and test computer games. The instructions are executable to stream one or more of the computer games to game play devices, receive from the game play devices game play data, and provide access to the game play data and/or analysis thereof to the respective game developers.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an end-to-end system for facilitating indie game development under the auspices of a computer game enterprise;

FIG. 3 illustrates a first component of a cloud service consistent with present principles;

FIG. 4 illustrates example logic in example flow chart format consistent with FIG. 3;

FIG. 5 illustrates further example logic in example flow chart format consistent with FIG. 3;

FIG. 6 illustrates further example logic in example flow chart format consistent with FIG. 3;

FIG. 7 illustrates a second component of a cloud service consistent with present principles;

FIG. 8 illustrates a third component of a cloud service consistent with present principles;

FIG. 9 illustrates example logic in example flow chart format consistent with FIG. 8;

FIG. 10 illustrates further example logic in example flow chart format consistent with FIG. 8;

FIG. 11 illustrates a fourth component of a cloud service consistent with present principles;

FIG. 12 illustrates a fifth component of a cloud service consistent with present principles;

FIG. 13 illustrates a sixth component of a cloud service consistent with present principles;

FIG. 14 illustrates example logic in example flow chart format consistent with FIG. 13; and

FIGS. 15-19 illustrate example screen shots consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

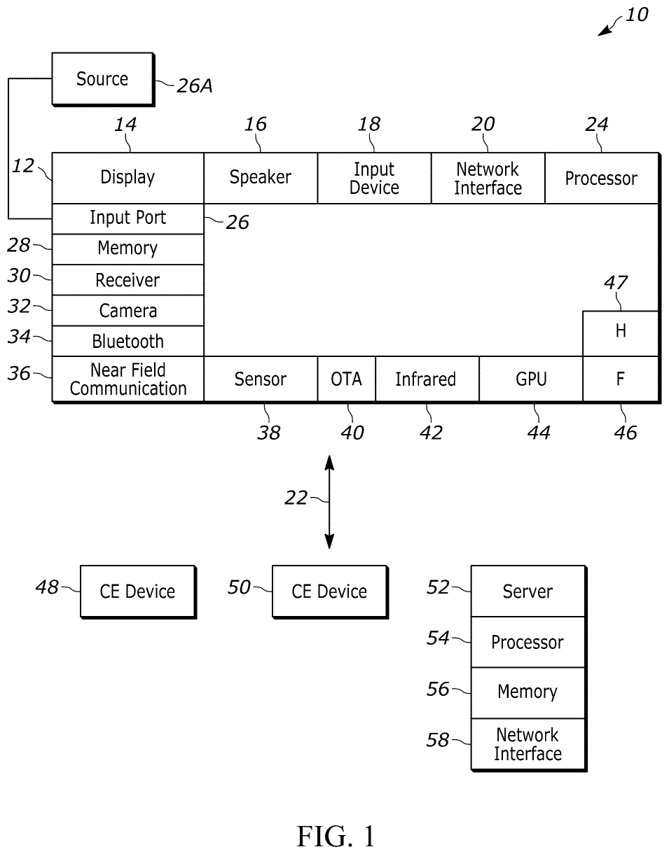

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

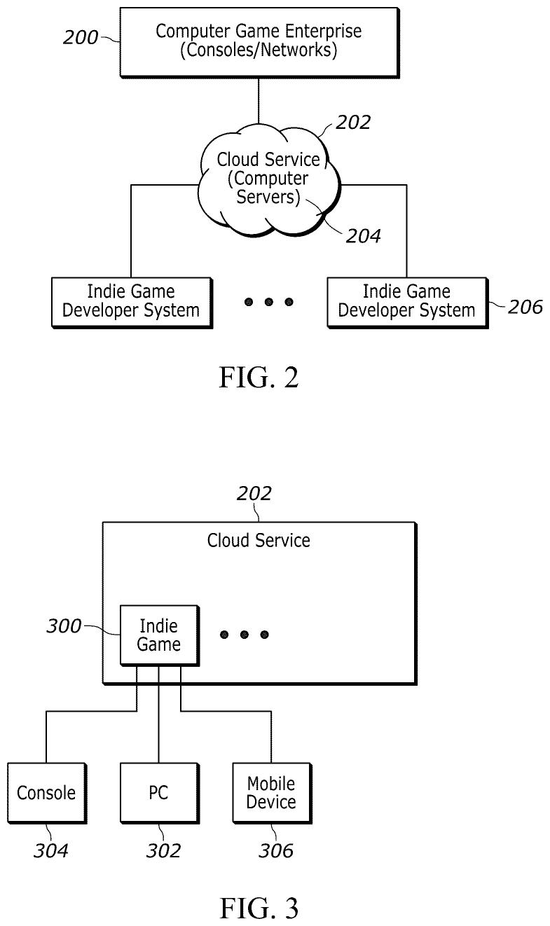

Refer now to FIG. 2. A computer game enterprise 200 that includes a network of servers and game consoles and other game play devices is shown. An example of an enterprise 200 is the PlayStation® ecosystem. The enterprise 200 may provide a cloud-based service 202 executed by one or more computer servers 204 to allow independent (“indie”) game developers using their respective computer systems 206 to access the cloud service 202 to develop, test, deploy, and analyze prototype computer games.

As shown in FIG. 3, The service 202 provides for cloud-native hosting and streaming of, for example, hypertext markup language (HTML) 5 games 300 to multiple devices including PCs 302, game consoles 304, and mobile devices 306, all of which may execute HTML5 apps.

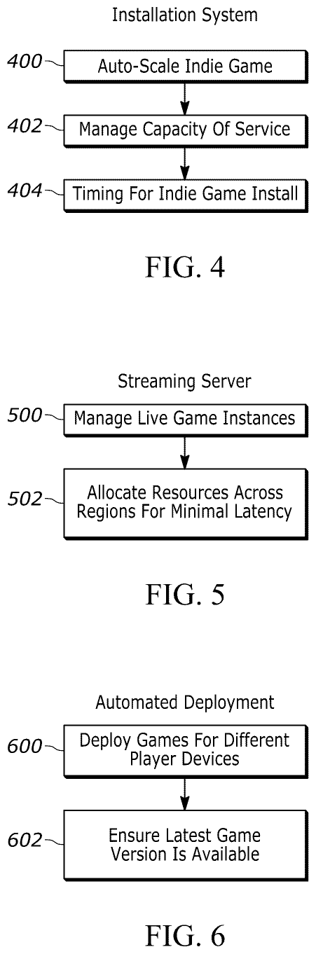

Several advanced technologies are integrated to optimize and support this system as shown in FIG. 4. An installation system fully automates the provisioning of cloud resources such as storage and compute power. It includes capabilities for auto-scaling of prototype games at state 400 as appropriate for various game devices, managing capacity of the service 202 at state 402, and optimizing timing at state 404, all secured with valid cloud credentials if desired. This automation ensures that resources are efficiently allocated, maintaining performance without manual intervention.

FIG. 5 illustrates logic of a streaming server associated with the service 202. Commencing at state 500, the streaming server manages live gaming instances, automating resource orchestration across multiple regions at state 502 to ensure that gamers experience minimal latency, ideally at the millisecond level for round-trip times.

FIG. 6 illustrates automated deployment logic that the service 202 may employ. At state 600 prototype games can be automatically deployed as HTML5 playables for PCs and mobile devices, supported by the aforementioned streaming server. This system simplifies the process of updating and distributing games, ensuring, at state 602, that the latest version is always available to players without the need for them to manually download updates.

These technologies collectively create a robust infrastructure that supports the rapid scaling of gaming applications, ensuring optimal performance and user experience across various devices and geographic locations.

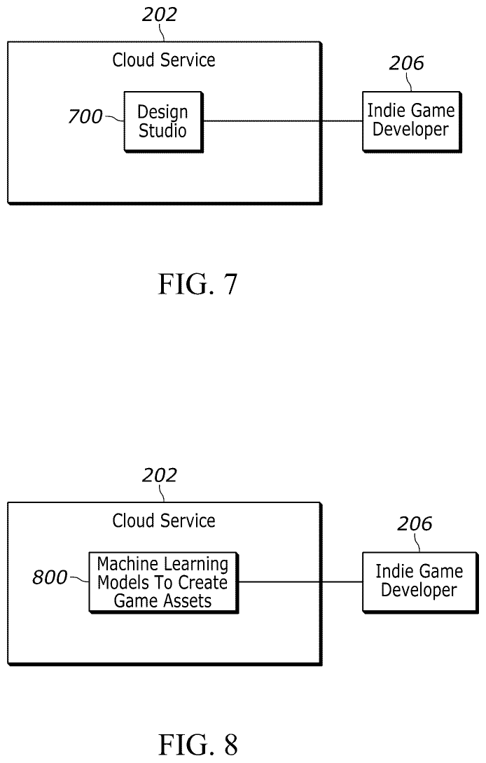

FIG. 7 illustrates another aspect of the cloud service 202. A cloud-based game design studio 700 can be provided to help indie developers 206 adapt their game designs, compatible with and agnostic to major gaming engines such as Unreal and Unity

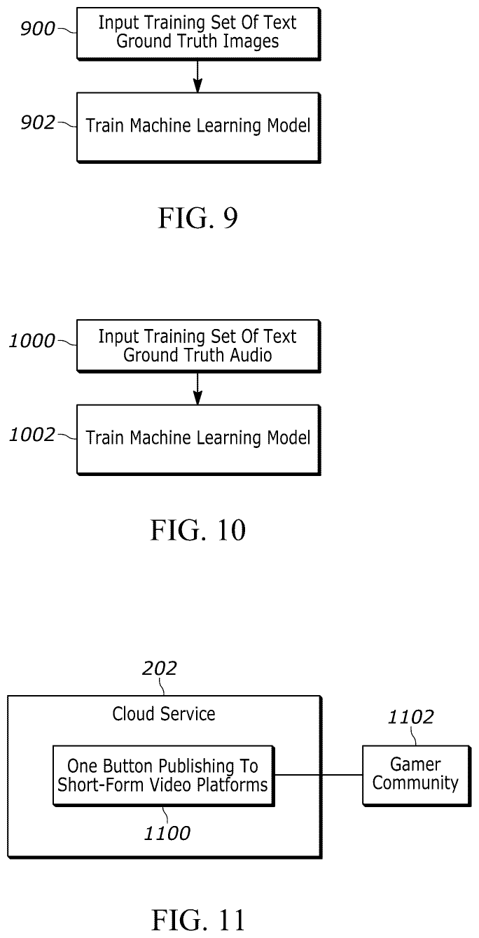

Cloud-hosted environment and toolsets for developers to develop and test games are also provided by the service 202, without having to have local hardware. FIG. 8 illustrates. The cloud service 202 can execute one or more AI-powered tools such as machine learning (ML) models 800 to automate the creation and reusability of game assets, including audio, video, 3D, images, non-players characters (NPCs), etc. These tools may include text-to-generate or text-to-curation of audio tracks, images, NPC dialogs and worldviews, etc. FIGS. 9 and 10 illustrate.

State 900 of FIG. 9 indicates that a training set of text and corresponding ground truth may be input to a ML model to train the model at state 902. Similarly, state 1000 of FIG. 10 illustrates that a training set of text and corresponding ground truth audio can be input to a ML model to train the model at state 1002.

The underlying technology may be based on fine-tuning of LLMs (large language models) and LVLM (large vision language models), based on relevant and license owned or permissible set of base assets. The fine-tuned models supports the use of text prompts to generate or customize set of creative varieties that meet the needs of the game production.

FIG. 11 illustrates that the cloud service 202 may further include integrated and one-button publishing to short-form video social platforms 1100 (TikTok, YouTube Shorts, etc.) for massive exposure to a diverse community of gamers 1102. This capability offers massive exposure to a diverse community of gamers, helping developers tap into a vast audience quickly and efficiently. The process simplifies the marketing and promotional efforts needed to gain visibility, allowing creators to focus more on game development while still engaging with their audience effectively. Playable content can be distributed to social media platforms via thin client integration, supported by the same robust streaming server that facilitates the deployment of longer content games on PC and mobile platforms. This integration ensures that short, engaging games, or “snackable” games, can be easily accessible and played directly from social media feeds without the need for heavy downloads or installations. These snackable games are designed to be quick and engaging, perfect for casual gamers looking for immediate entertainment, and they serve as a great tool for developers to increase interest and retention among users.

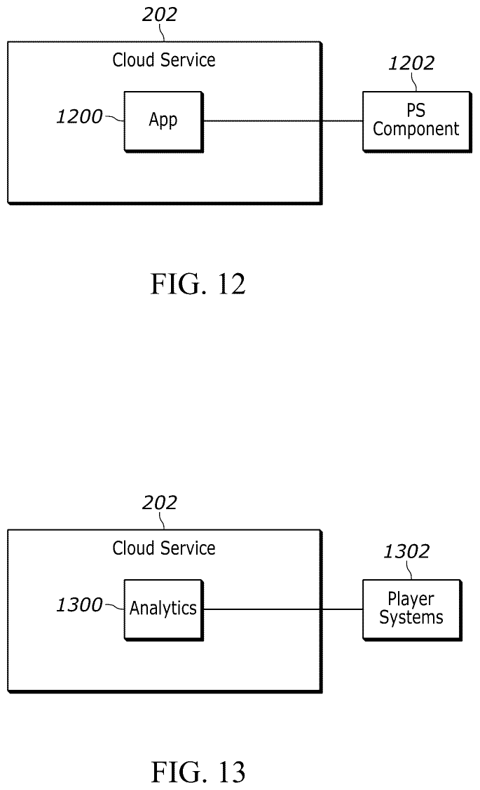

FIG. 12 illustrates that the cloud service 202 may be accessible as an app 1200 on various gaming components 1202 such as a game console or game app, with game system subscribers having full access to all games on the platform

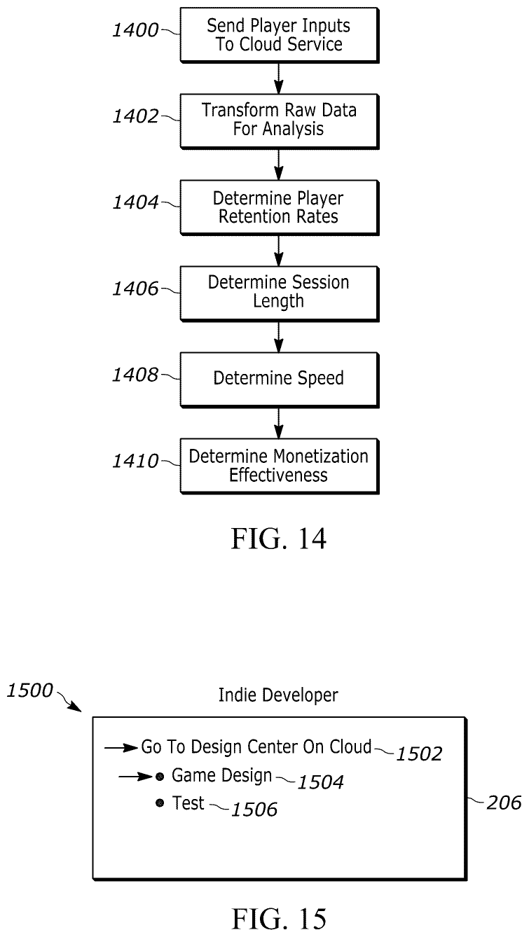

In addition to the above features, FIG. 13 illustrates that the cloud service 202 may include out-of-the-box experimentation capabilities and analytics 1300 to analyze game performance from player systems 1302 playing the prototype games streamed from the service 202 and provide actionable insights for improvement. FIG. 14 illustrates further.

Player inputs from game play devices executing prototype computer games streamed from the service 202 may be sent back to the service 202 at state 1400. This telemetry of key in-game interactions can be pre-built into the cloud game design studio, enabling developers to automatically track and analyze player behaviors and game mechanics without the need for extensive manual setup. This telemetry can include metrics such as player engagement times, level completion rates, and other user interactions for understanding gameplay dynamics and player preferences.

Further enhancing this capability, the cloud-based service also incorporates advanced features for variant allocation and the transformation of raw telemetry data at state 1402 into evaluatable data assets suitable for experiment analysis. This functionality is for conducting A/B testing and other forms of performance evaluation, allowing developers to refine and optimize their games based on empirical data. Included in the service are tools for monitoring common metrics for assessing game performance, such as player retention rates which may be determined at state 1404 by analyzing how well the game keeps players engaged over time as indicated by, e.g., input activity to the game. Game session length may be determined at state 1046 from the average amount of time players spend in the game per session. Also, player progression speeds may be determined at state 1408 by analyzing how quickly players are moving through the game levels or content. Monetization effectiveness may be determined at state 1410 by determining how effectively the game converts players into paying users and the revenue generated from in-game transactions. These built-in tools and metrics provide developers with a comprehensive overview of how their games are performing and where improvements can be made, ultimately leading to a more engaging and successful gaming experience for users.

Note that when prototype games “graduate” from the above platform 202, the computer game enterprise 200 in FIG. 2 may be accorded joint ownership of the content IP and rights for exclusive console licensing. This platform thus provide a systematic pathway for indie game developers to test and evolve their ideas, with access to a massive community of gamers and a suite of tools to help them create high-quality games. By providing joint ownership of the content IP and exclusive console licensing rights, the computer game enterprise 200 can incentivize developers to create games that are optimized for platforms of the computer game enterprise 200, while also providing a clear pathway for developers to transition to console platforms when their games are successful.

FIGS. 15-19 illustrate example screen shots of user interfaces (UI) that may be provided on components herein. In FIG. 15, indie game developer systems 206 may present a UI 1500 with a selector 1502 to access the service 202. The UI 1500 may include a selector 1504 to access game design features of the service 202, such as the ML models described above for generating game assets. A test selector 1506 may be provided to allow the developer to test a prototype game by making it available for download from the service 202 to the game play devices 302-306 shown in FIG. 3.

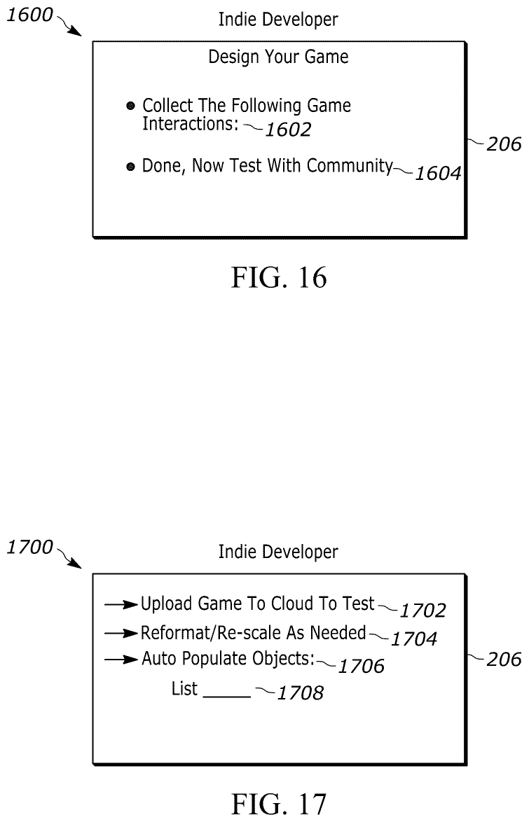

FIG. 16 illustrates a UI 1600 that can be presented on an indie game developer system 206 to facilitate game design. An input element 1602 may be provided to allow the developer to specify what game play data from game play devices playing the developer's prototype game to collect from the game play devices. A one-button selector 1604 can be selected to cause the prototype game to be made available to the game community via the service 202.

FIG. 17 illustrates a UI 1700 that can be presented on an indie game developer system 206 to further facilitate game design. An upload selector 1702 may be provided to upload the prototype game to the service 202 for test/development. Also, a format/scale selector 1704 can be selected to cause the service to reformat and/or rescale the prototype game as appropriate for the various game play devices in the ecosystem that are expected to play the game. A selector 1706 may be selected to automatically populate the game with audio and video images using ML as described above from a list 1708 that the developer may provide specifying the desired objects to be created.

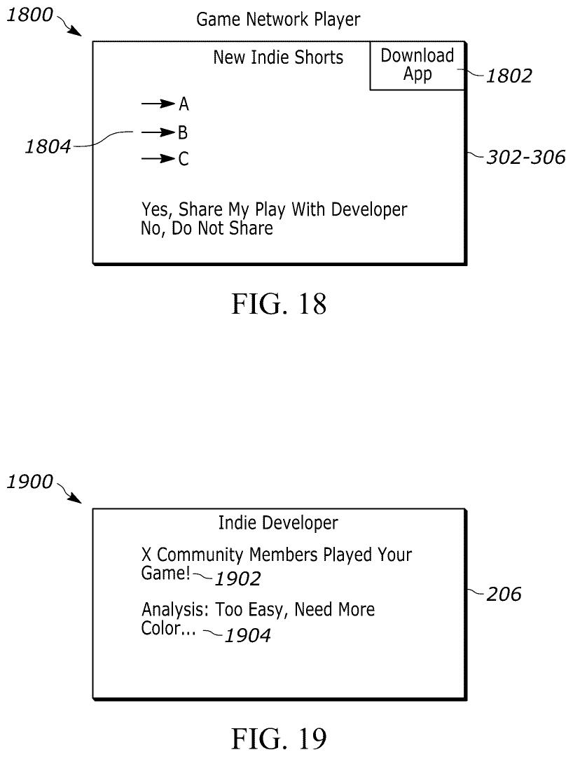

FIG. 18 illustrates a UI 1800 that can be presented on any of the game play devices 302-306 shown in FIG. 3. A selector 1802 can be used to select to download the app 1200 from FIG. 12 to play prototype games streamed from the service 202. A list 1804 of prototype games available for streaming may be provided for selection of an entry on the list to play on the game play device. Selectors 1806 and 1808 may be provided for selection to respective grant or deny sharing of the player's game play input data with the service 202.

FIG. 19 illustrates a UI 1900 that can be presented on an indie game developer system 206 to provide results of community play of the developer's prototype game. An indication 1902 may be presented of the number of community players who downloaded and played the game. Analysis results 1904 derived from the game play data from the game play devices may be presented consistent with disclosure herein.

Indie game developers thus are provided, through the cloud service 202, access to a larger audience of potential players, which can help increase their game's visibility and popularity. The service 202 also provides cost-effective development using the platform's cloud-based infrastructure and AI-powered tools can help reduce the cost and time required for game development, making it more accessible to indie developers. The service 202 also provides for improved monetization through the platform's suite of tools that can help developers monetize their games more effectively, including through in-game purchases, subscriptions, and advertising. The platform's integration with short-form video social platforms can help developers gain more exposure for their games and attract new players. The platform's analytics and experimentation capabilities can provide developers with continuous feedback and insights on how to improve their games, helping them to iterate and refine their products more quickly and effectively.

While the particular embodiments are herein shown and described in detail, it is to be understood that the subject matter which is encompassed by the present invention is limited only by the claims.

What is claimed is:

1. A method comprising:
providing a cloud-based service executed by at least one network server;
the service provisioning cloud resources including storage, compute power, and auto-scaling of at least a first prototype computer game for execution on at least a first game play device;
deploying, from the service, the first prototype computer game to the first game play device;
receiving game play data from the first game play device; and
providing analysis results of the first game play data to an independent (indie) developer of the first prototype computer game.

2. The method of claim 1, comprising using the service to provide a game design studio to help modify the first prototype computer game.

3. The method of claim 1, comprising using the service to test the first prototype computer game.

4. The method of claim 1, comprising using the service to execute at least one machine learning (ML) model to automate creation of at least one asset for the first prototype computer game.

5. The method of claim 4, wherein the asset comprises an image of a background game object, or character dialog, or a game character.

6. The method of claim 1, comprising:
providing an app to the first game play device enabling the first game play device to access the first prototype computer game.

7. The method of claim 6, wherein the first game play device comprises a game console.

8. The method of claim 6, wherein the first game play device comprises a mobile communication device.

9. The method of claim 1, comprising allowing the indie developer of the first prototype computer game to specify the game play data to be collected from the first game play device.

10. The method of claim 1, wherein the game play data comprises player engagement times and level completion rates.

11. The method of claim 1, wherein the game play data comprises one or more of player retention rate, game play session length, player progression speed.

12. A processor system configured to:
receive communication from an independent (“indie”) developer of a first prototype computer game at at least one server over a wide area network;
using the server, enable the indie developer to develop the first prototype computer game;
using the server, provide the first protype computer game over the wide area network to at least a first game play device;
receive game play data at the server from the first game play device executing the first prototype computer game; and
provide analysis of the game play data to the indie developer.

13. The processor system of claim 12, wherein the processor system is configured to:
execute at least one machine learning (ML) model to automate creation of at least one asset for the first prototype computer game.

14. The processor system of claim 13, wherein the asset comprises an image of a background game object, or character dialog, or a game character.

15. The processor system of claim 12, wherein the first game play device comprises a game console or a mobile communication device.

16. The processor system of claim 12, wherein the processor system is configured to:
receive input from the indie developer specifying the game play data to be collected from the first game play device.

17. The processor system of claim 12, wherein the game play data comprises at least two of: player engagement times, level completion rates, player retention rate, game play session length, player progression speed.

18. An apparatus comprising:
at least one computer memory that is not a transitory signal and that includes instructions executable by at least one processor system to:
establish on at least one network server a facility to allow game developers to develop and test computer games;
stream one or more of the computer games to game play devices;
receive from the game play devices game play data; and
provide access to the game play data and/or analysis thereof to the respective game developers.

19. The device of claim 18, wherein the instructions are executable to:
execute at least one machine learning (ML) model to automate creation of at least one asset for the computer games.

20. The device of claim 18, wherein the instructions are executable to:
receive input from at least a first one of the game developers specifying the game play data to be collected from the game play devices.
